(19) United States
(12) Patent Application Publication
(10) Pub. No.: US 2017/0104807 A1
(43) Pub. Date: Apr. 13, 2017

(54) SYSTEMS AND METHODS FOR REMOTE CONTROL OF COMPUTERS

(71) Applicants: Matthew Braun, Mill Creek, WA (US); Maria Braun, Mill Creek, WA (US)

(72) Inventors: Matthew Braun, Mill Creek, WA (US); Maria Braun, Mill Creek, WA (US)

(21) Appl. No.: 14/877,418

(22) Filed: Oct. 7, 2015

(51) Int. Cl. H04L 29/08; H04L 29/06; H04L 12/26

(52) U.S. Cl. CPC H04L 67/025; H04L 43/10; H04L 63/102; H04L 63/08

(57) ABSTRACT

Systems and methods for remote control of computers and computing devices, such as tablets and mobile phones, including control software run on a control device, and a client application running on one or more controlled devices in network communication with the control device. The control device can be used to selectably lock or otherwise control the controlled device from further usage. In some examples, the systems and methods include multiple controlled devices. In some further examples, the systems and methods include a third-party provider that stores user credential information and generates corresponding external IDs, and both the control software and client application query the third-party provider upon startup to validate that the controlling user is authorized to lock the controlled devices.

### CROSS REFERENCE TO RELATED APPLICATIONS

This application claims priority to copending U.S. Provisional Application, Ser. No. 62/063,775, filed on Oct. 14, 2014, which is hereby incorporated by reference for all purposes.

### BACKGROUND

The present disclosure relates generally to computer system access controls. In particular, systems that allow for the remote locking of a computer using a client-server model are described.

Internet-connected computers are ubiquitous. The benefits of instantly accessible information provided by the Internet make such computers indispensable research and communications tools. However, while undeniably useful, Internet-connected computers also can become distractions. The availability and popularity of online games and social media forums results in many children spending inordinate amounts of time on their computers. If the subject of their interest is sufficiently engaging, it can be difficult to get children to step away from their computers and give attention to other matters, such as parental requests. Repeated resistance to leave the computer can frustrate the most patient of parents. It is desirable, then, to provide a mechanism by which parents can forcibly discontinue computer usage in the event the parents' child refuses to leave the computer, and do so in a fashion that prevents circumvention by the child.

In a similar fashion, a system which can be used to remotely deny access to a computer to prevent unauthorized use while allowing authorized use for when the system's owner is physically away is useful. Such a system can also find use in a business environment to provide remotely controllable selective access to computer systems, and/or to also allow for remote securing of workstations.

Known systems and methods for forcibly denying computer access are not entirely satisfactory for the range of applications in which they are employed. For example, existing systems such as Apple's Find My iPhone® system allow for remote locking of mobile devices and computers that are signed into the system. However, Find My iPhone® is limited to Apple's devices and computers only, requires connection to Apple's services for operation which necessitates an active Internet connection, and merely engages the locked device's existing passcode. In the case of computers, there is no ability to provide a message to the user. In the vast majority of circumstances, the user of the device knows the passcode, and can easily unlock the device or computer. A third-party system known as Ignore No More allows the creation and entry of a temporary locking password. However, ignore No More only works on mobile devices based on the Android® operating system, does not offer a solution for locking a laptop or desktop computer, and also requires an active Internet connection as it relies upon Ignore No More's central servers for operation. For situations where access to a computer system by persons other than the owner is needed while the owner is physically away from the system, traditional means require either the person needing access to be given the owner's password, thus compromising password integrity and/or requiring a password change upon the owner's return, or the person to locate an administrator with override authority (if such a person exists), increasing the effort and time required to access a computer system.

Thus, there exists a need for locking systems and methods that improve upon and advance the design of known computer and device locking systems. Examples of new and useful locking systems and methods relevant to the needs existing in the field are discussed below.

### SUMMARY

The present disclosure is directed to systems and methods for remote control of computers and computing devices, such as tablets and mobile phones. A control software application is run on a control device, and can communicate via network to a controlled device running a corresponding client application. Once contact is made between the control software and client application, the control device can be used to lock out the controlled device from further usage until the user of the control device releases the lock. If desired, a message, can be displayed on the screen while the controlled device is locked. In some examples, the systems and methods include multiple controlled devices, and the control software application allows the user to select between the multiple controlled devices to determine which device to lock. In some further examples, the systems and methods include a third-party provider that stores user credential information and generates corresponding external IDs, and both the control software and client application query the third-party provider upon startup to validate that the controlling user is authorized to lock the controlled devices.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 is a diagram of the components of a computer network implementing an example of a system for remotely locking a computer.

FIG. 4 is a screen capture of the control software for the example system for remotely locking a computer showing the computer system as locked.

FIG. 5 is a screen capture of the control software for the example system for remotely locking a computer showing the computer system as unlocked.

FIG. 6 is a screen capture of an example lock screen shown when a computer is remotely locked in the example system for remotely locking a computer.

FIG. 7 is a flowchart of the steps executed by an example method for remotely locking a computer.

FIG. 8 is a flowchart of the steps executed for authentication of a control software user by an example method for remotely locking a computer.

### DETAILED DESCRIPTION

The disclosed systems and methods will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various systems and methods are provided. Related features in the examples may be identical, similar, or dissimilar in different examples. For the sake of brevity; related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

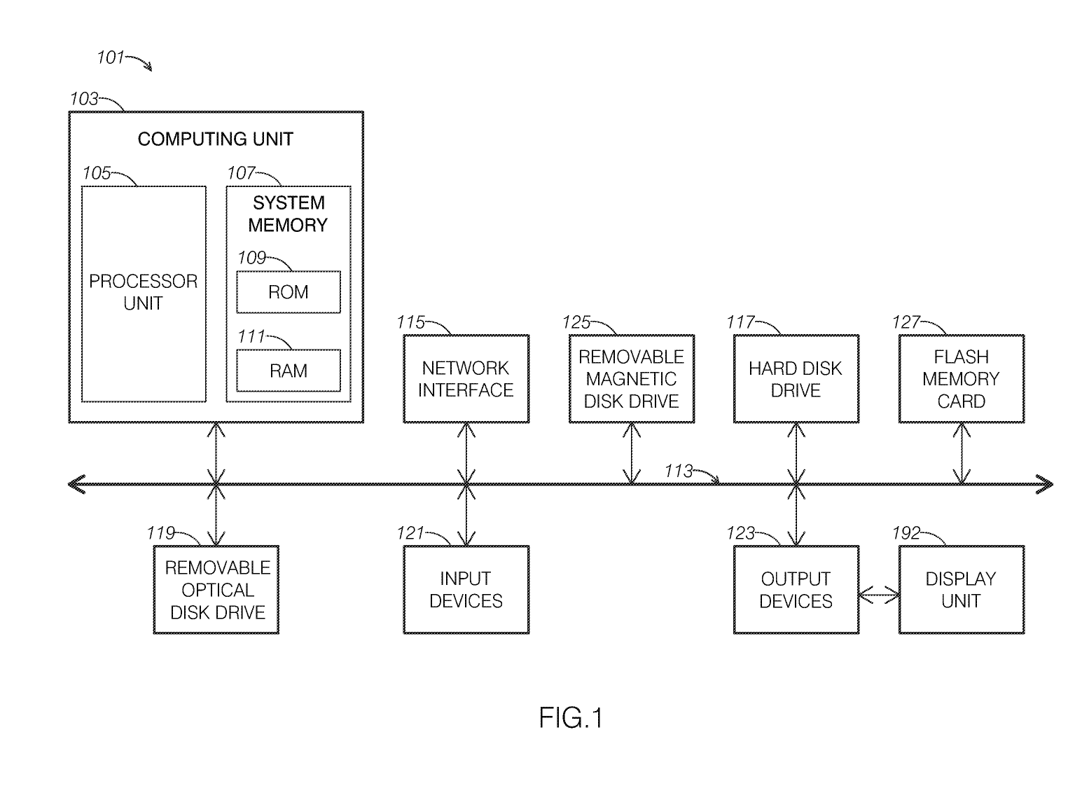

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include froth a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, etc.), recording or playing back sound tiles, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their data maintained may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Windows-based (including Windows Mobile and Windows 8), or Android operating systems.

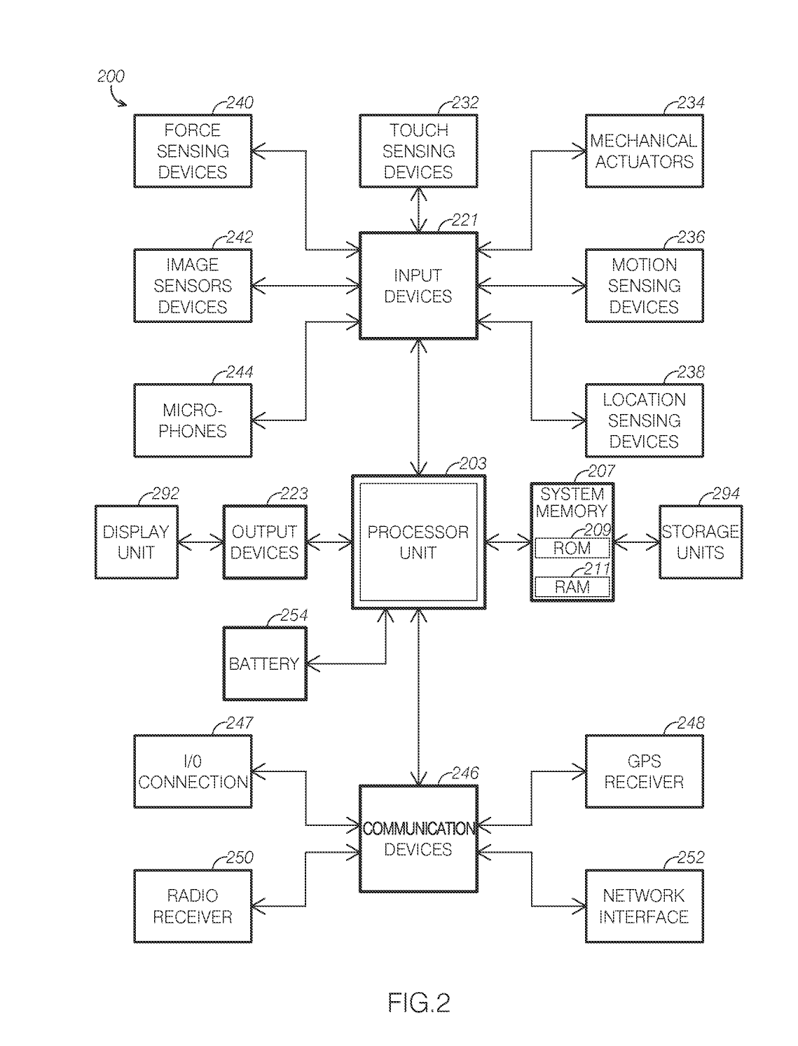

With reference to FIG. 2, an exemplary mobile device, mobile device 200 may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well-known operating systems such as iOS, Symbian, Windows-based (including Windows Mobile and Windows 8), or Android operating systems, or alternatively to special purpose operating system, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices 240 such as force sensitive displays and housings; image sensors 242; and microphones 244. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

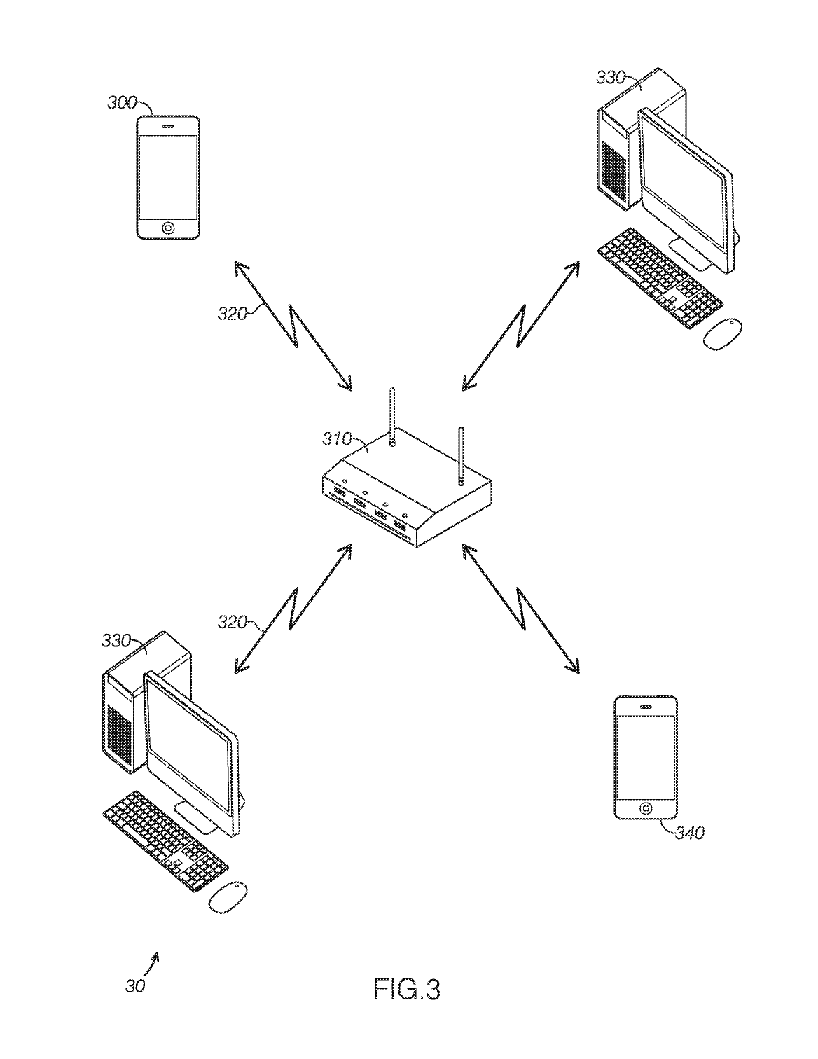

With reference to FIG. 3, a first example of a system, system 30, will now be described. System 30 functions to allow a computer system to be remotely controlled, including being locked or unlocked remotely, over a computer network, and optionally displaying a message of the locking user's choice on the computer system's screen when locked. Additionally or alternatively, system 30 can be used to control or lock a mobile device such as a smartphone or tablet.

System 30 addresses many of the shortcomings existing with conventional systems for remotely locking computers. For example, ideally, the system 30 is implemented such that all locking and unlocking is controlled separately from the locked computer, e.g. on the device that runs the control software, with no option to enter a passcode on the locked computer. This eliminates the possibility of a user circumventing the lock by entering a known password. Further, the system 30 is implemented using software calls that can operate directly over the network between a device with the control software and a computer to be locked. In this way, dependence on an Internet connection to connect to third-party controlled servers is eliminated.

As shown in FIG. 3, one possible embodiment of system 30 includes a control device 300 which runs control software to lock and unlock computer systems remotely, a network router 310 that facilitates communication between the control device 300 and the devices to be remotely controlled via data links 320, and a controlled device, such as computer system 330 and/or mobile device 340, which can communicate with the control device 300 to be remotely locked or unlocked. In other examples, the system 30 includes multiple instances of controlled device computer system 330 and/or mobile device 340, which can each be locked or unlocked independent of all other systems or devices, or multiple instances of control device 300, each of which is capable of locking or unlocking a controlled device such as computer system 330 or mobile device 340. In still other examples, the network router 310 can be entirely omitted, with the data link 320 running directly between the control device 300 and controlled devices computer system 330 and/or mobile device 340.

Control device 300 is comprised of a computer system which can be a computer, as disclosed above in FIG. 1 and its associated description, a mobile device, as disclosed above in FIG. 2 and its associated description, or any other device capable of running the control software for locking and unlocking computer systems remotely, including a purpose-built device. Computer system 330 comprised of any computer capable of running the client locking software that is controlled by the control software, such as a computer disclosed in FIG. 1 and its associated description. Likewise, mobile device 340 is comprised of any mobile device capable of running the client locking software, such as a mobile device as disclosed above in FIG. 2 and its associated description. The control software communicates with the client locking software over a network to which the control device 300, and controlled devices computer system 330 and/or mobile device 340 are commonly connected. Communication between the control software and client locking software can occur over a local area network, such as a home network formed using a single WiFi or Ethernet router, or larger scale networks up to wide-area networks such as the Internet, so long as the control software can contact the client locking software over TCP/IP protocols.

Network router 310 facilitates communication of a control device 300 with a controlled device such as computer system 330 or mobile device 340, by establishing a data link 320 between itself and control device 300, computer system 330, and mobile device 340, respectively. It will be appreciated by a person skilled in the relevant art that network router 310 may be unnecessary depending on the nature of the data links 320. Similarly, network router 310 may be implemented as a collection of various devices and systems capable of routing data between any connected systems or devices. Examples of such an implementation include local area networks, wide area networks, and the Internet, which is capable of routing information between any devices or systems connected to the Internet. Likewise, data link 320 may be implemented as a wireless connection using commonly available WiFi technology, over cellular or wireless data networks, or any other known or later developed wireless data transmission technology, or as a hard-wired connection using Ethernet, a fiber optic connection, or any other data transmission technology that uses a solid medium of transmission that is now known or later developed.

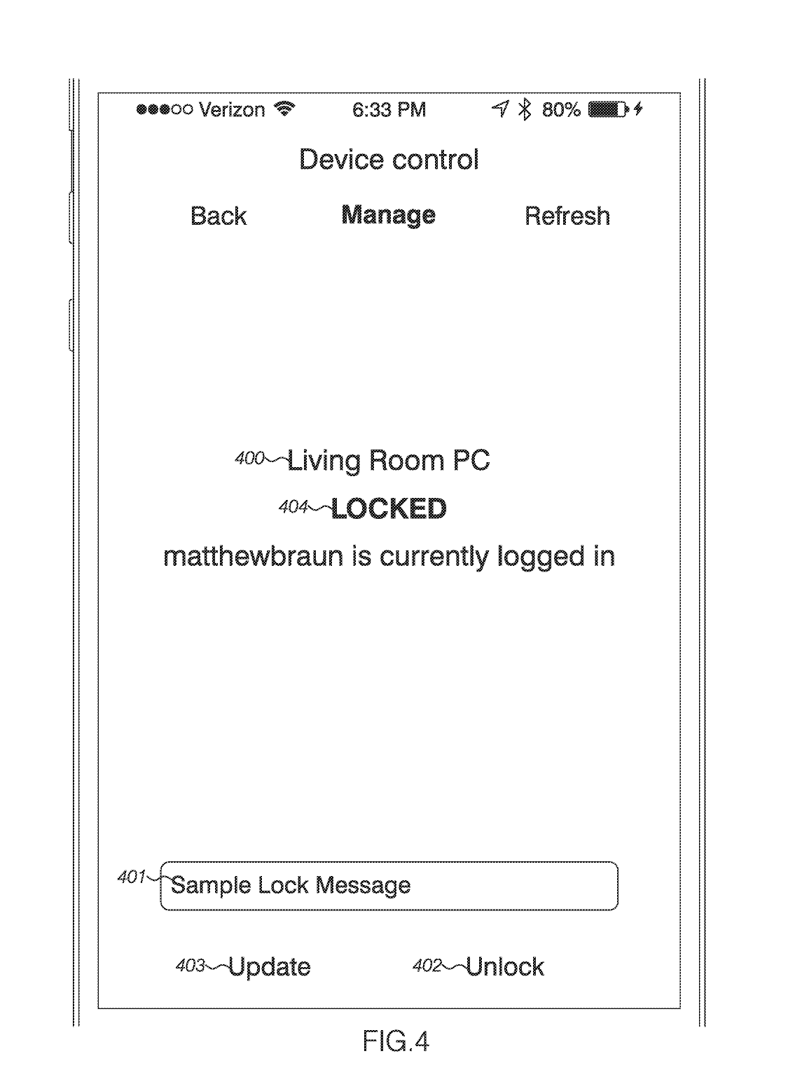

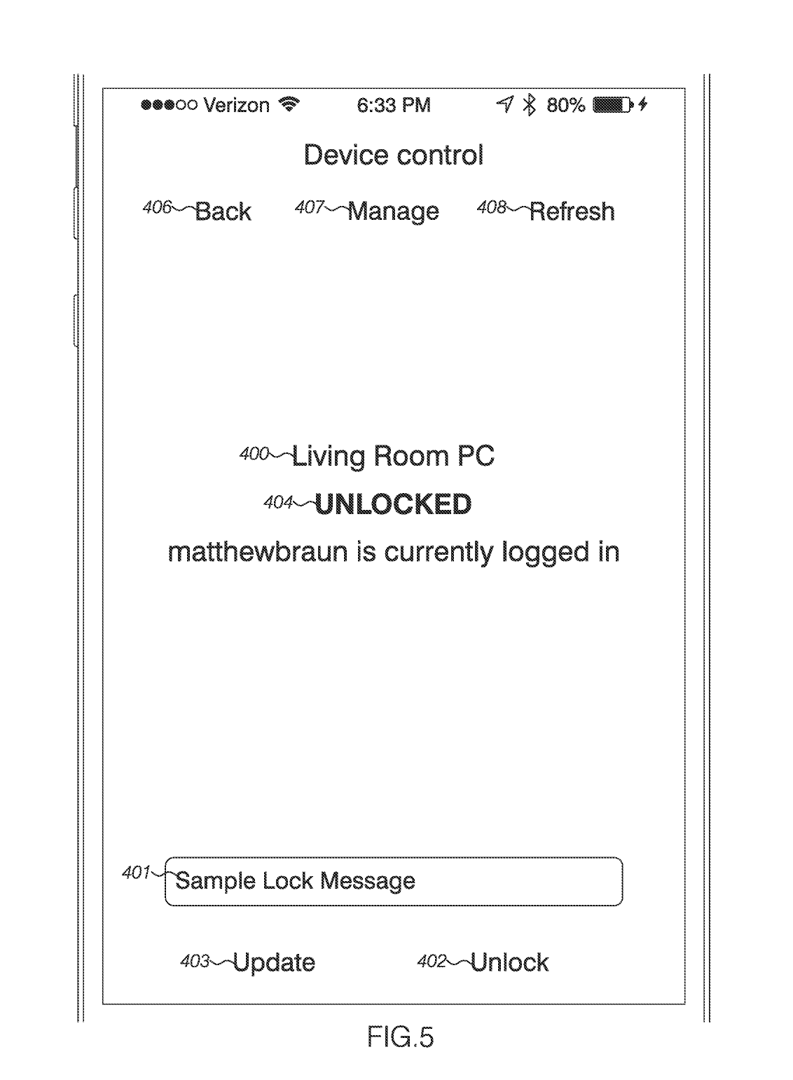

Turning attention to FIGS. 4 and 5, screen shots of the control software are shown. Here, the control software is shown on the screen displaying the status of a selected remotely locked computer system 400, showing the status 404 as locked (FIG. 4) or unlocked (FIG. 5). A message box 401 is provided for displaying a message on the remotely locked computer system. The remote system is locked or unlocked using selecting buttons 402 and 405, respectively. An update button 403 is provided to update the status of the remote system, as well as to allow changing the displayed message if it is updated in message box 401. Also seen are a back button 406, which takes the user to a screen that allows selection of other devices (computer systems or mobile devices) running the client locking software that are in communication with the control software, a manage button 407, which allows the user to change optional settings on the remotely locked computer system 400, including adding or removing authorized users, and a refresh button 408, which causes the control software to requery the remotely locked computer system 400 to update its status information. The screen shots provided in FIGS. 4 and 5 show the control software running on an Apple® iOS device, such as an iPhone®. This software can also be implemented on an Android® device, a Microsoft Windows® tablet or phone, or any computer system running a commonly available operating system such as Mac OS, Microsoft Windows®, or Linux.

The control software can also be optionally equipped with functionality that allows a user to schedule remotely locked computer system 400 to be locked at some future time, as opposed to immediate locking. Such functionality can be performed either in the control software, or in the client locking software. When implemented in the control software, the user would schedule a lock at a future time, and the control software would either periodically check the elapsed time or, if the hardware and software platform underlying the control software so supports it, set a system alarm to alert the control software upon completion of the elapsed time, whereupon the control software would send the lock command to the client locking software. Alternatively, implementing such functionality in the client locking software would have the control software send both a lock command and an associated time (e.g. now, or at some point in the future), whereupon the client locking software would handle monitoring the elapsed time or setting an alarm. Upon completion of the elapsed time, the client locking software would lock the remotely locked computer system 400. Implementing a time-delayed lock on the client locking software side has the advantage of providing a “set and forget” functionality, where the control device 300 need not be in network communication (or even powered on, for that matter) with the remotely locked computer system 400 once the time for locking arrives. Conversely, implementing a time-delayed lock on the control software can allow for delayed locking of remotely locked computer systems 400 that do not or are unable to support monitoring of elapsed time.

Further to the delayed locking functionality described above, delay functionality can be implemented in an automated fashion in connection with calendaring functionality, thereby enabling automatic schedules to be created where remotely locked computer system 400 is made available only at pre-designated times throughout the week, and is otherwise locked.

One possible implementation of delayed locking functionality in client locking software includes the client locking software updating a configuration file stored upon remotely locked computer system 400 upon receipt of a lock command that is tagged with a future time, and updating a built-in scheduler (such as Quartz Scheduler) with the appropriate lock command information. The client locking software sends confirmation back to the control soft indicating successful scheduling of the lock command and, once the scheduler indicates that the scheduled lock time has arrived, the client locking software executes a lock similar to having received an immediate lock request. In some implementations, the control software could be sent confirmation that the remotely locked computer system 400 has been locked.

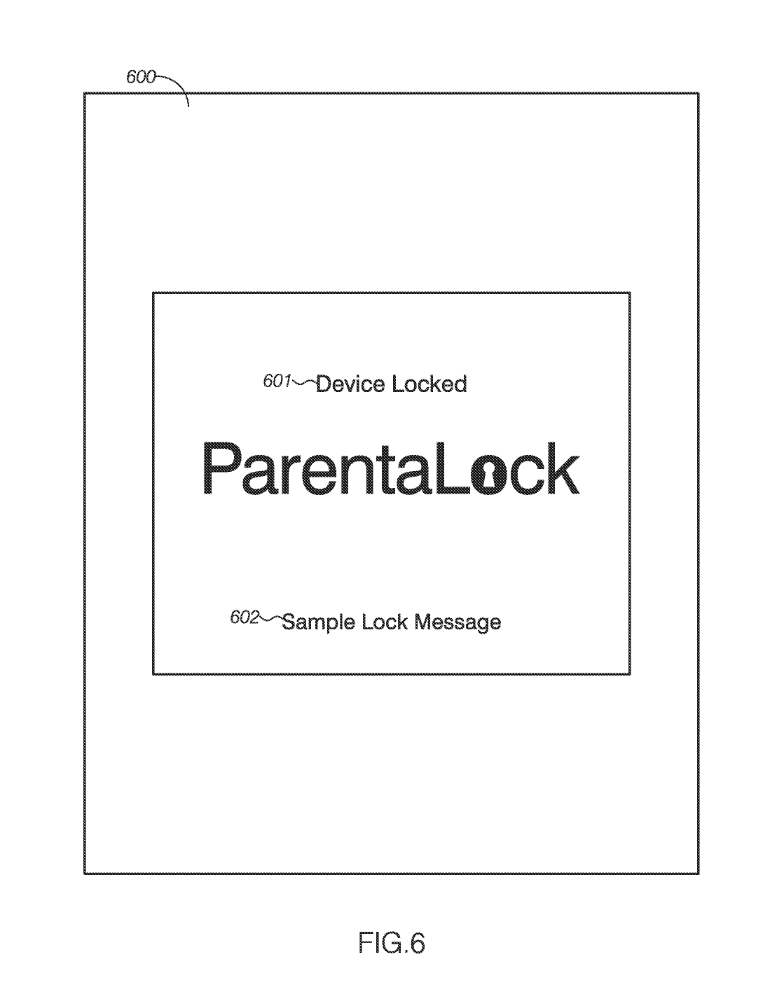

In the example shown in FIG. 6, the lock screen 60 displayed on a remotely locked computer system 330 is shown. A message window 601 is shown once the remote system is locked, along with the optional lock message 602, as provided by the user via message box 401. The background surrounding the message window 601 can be customized by, for example, color, transparency, image, etc., depending on the user's preferences and the client locking software configuration.

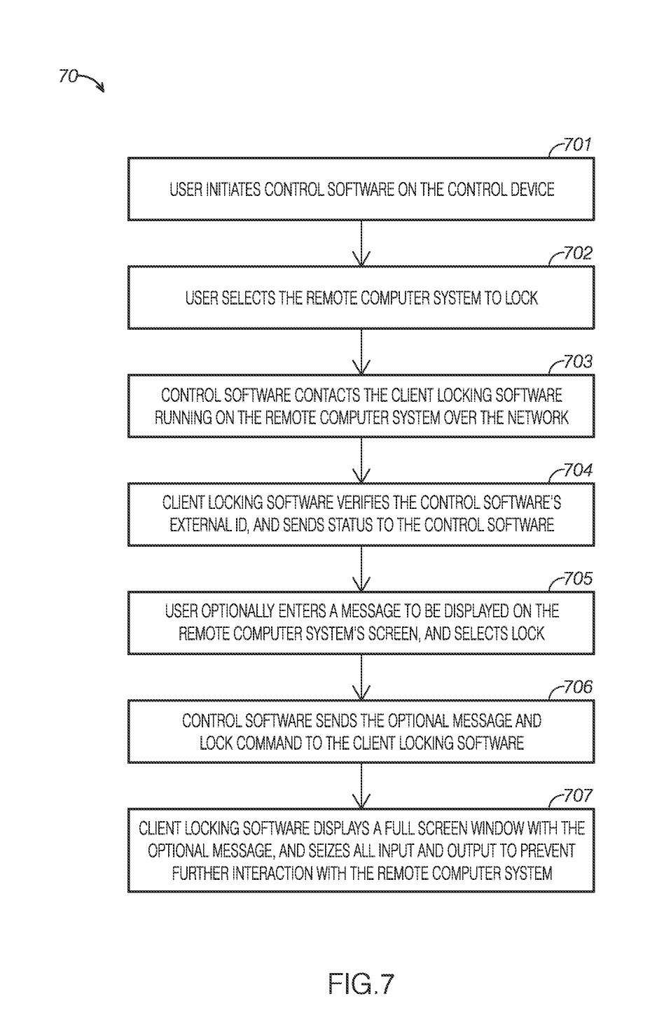

Turning attention to FIG. 7, a method 70 of using the disclosed system 30 will now be described. Method 70 assumes that control software has been previously installed and configured on the control device 300 and client locking software has been previously installed and configured on at least one computer system 330 or mobile device 340. Method 70 includes step 701, initiation of the control software by the user on the control device 300, followed by selection of the computer system 330 or 340 to remotely lock in step 702. Next, in step 703 the control software contacts the client locking software on the selected computer system. If a system 30 executing method 70 implements user authentication, upon contacting the client locking software, the control software also provides its external ID, which the client locking software verifies in step 704 and, provided it matches a valid user on file with the client locking software, the client locking software then transmits its status to the control software. If system 30 does not implement user authentication, then step 704 is skipped. In step 705, the user supplies an optional message to be displayed on the lock screen, and selects the lock button. The control software sends the lock command and lock message to the client locking software on the remote computer system in step 706. Finally, in step 707 the client locking software executes the received commands, and displays a full-screen window with the optional locking message, and seizes control of computer input to effectively lock a user of the remote system from further use.

In step 701, when the user starts the control software, it polls its network connection to determine the existence of any computer systems on the network that are running the client locking software. If supported by the network, the control software can automatically locate computer systems and mobile devices running client locking software. Alternatively, the user can supply the control software with a list of network addresses of computers running the client locking software to be controlled. In some embodiments, the control software must first authenticate itself to the client locking software by supplying an external ID to the client locking software upon contact, which the client locking software then compares against an existing database of authorized external IDs. If the control software does not supply an authorized external ID, the client locking software rejects the connection, and the computer system running the client locking software does not appear or is unavailable via the control software. The user authentication system will be discussed in further detail herein.

Considering step 706, in one possible implementation, the client locking software, upon receiving a lock command from the control software, generates a full screen window, which it places over all other windows, preventing navigating away to another application. This can be accomplished by, for example, designating the window as modal, where it must be closed prior to any further action being allowed on the controlled system. It simultaneously intercepts and disregards all input to the controlled device., e.g. keyboard, mouse, touch screen, to prevent a user from further interacting with the system until it is unlocked; where a window is employed, this prevents the window from being closed. The appearance of the window, in addition to displaying an optional message the user provides, can be customized to have different backgrounds, different colors, and transparency levels, which can be selected to at least partially obscure the contents tit the screen if desired. The client locking software must be installed on the remote controlled device prior to utilization. To prevent removal or tampering with the client locking software in order to defeat its lock capabilities, the software is ideally installed using an administrator-level account on the remote controlled device, so that removal by ordinary users is not possible without supplying an administrator password. Furthermore, or in the alternative, the client locking software could be equipped with an anti-tampering routine that locks the computer in the event the software is attempted to be removed, and notifies the user via the control software. Finally, the software ideally is configured to as to immediately reinstate the lock on restart in the event the controlled device is shut down while locked, e.g. due to a power failure or hard reset.

It will be appreciated by a person skilled in the relevant art that a window is only one possible implementation. Any method that allows at least for effectively seizing control of the controlled device while preventing any further input from a user physically located with the controlled device from being accepted is within the contemplated scope of the disclosed invention. The methods employed may vary depending on the operating system running upon the controlled device, and the sorts of capabilities it offers to effectively remotely disable use of the device.

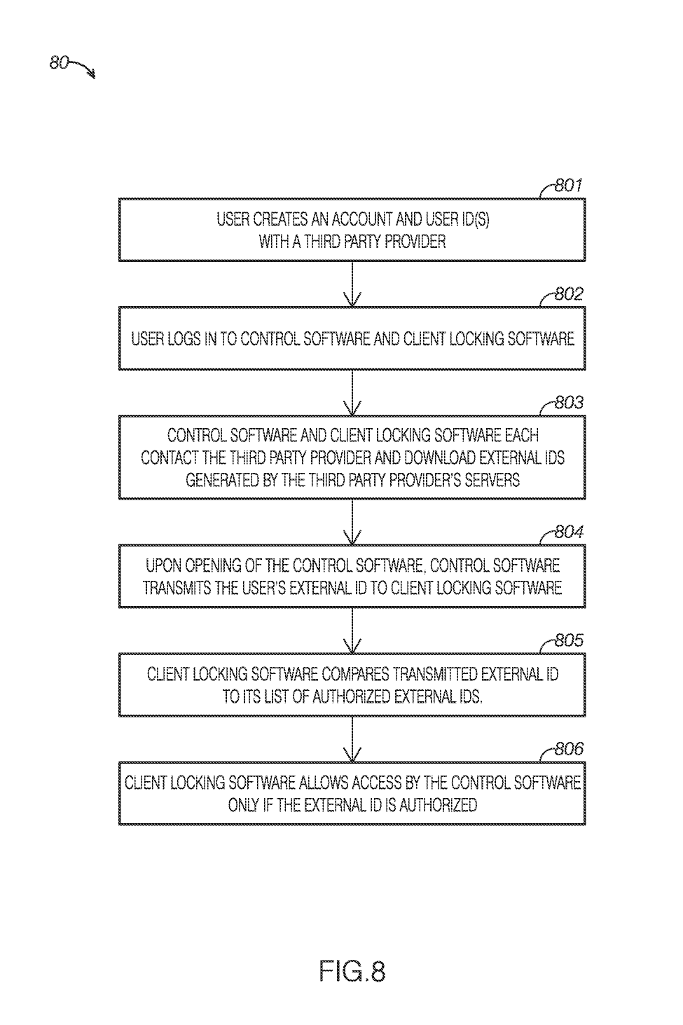

FIG. 8 illustrates method 80, ideally deployed in conjunction with method 70 on system 30, for authorizing users to lock, unlock, and otherwise manage computer systems and mobile devices running client locking software. This method 80 provides a means to prevent users of computer systems and mobile devices to be remotely locked from circumventing a lock by downloading a copy of the control software, and then using it to unlock the locked computer system or mobile device.

In step 801, a user creates an account with a third-party provider, preferably the vendor of the control software and client locking software, although any provider that can securely generate a unique ID and associate with the user can be utilized. During account creation the third-party provider receives credentials from the user, such as a login and password combination, although any method of uniquely identifying a user can be utilized, e.g. smartcard, biometrics, PIN code, etc. While creating the account, the user can optionally add different people to the account. The third-party provider then generates and stores a unique external ID for each person on the account created by the user.

Following installation of the control software and client locking software, in step 802 the user is required to provide his or her account information as provided to the third-party provider upon first launching the control software and the client locking software. The control software and the client locking software each then contact the third-party provider's servers in step 803, and download the list of unique external IDs associated with the user's account information. While this potentially necessitates an Internet connection for the initial startup and configuration of the control software and client locking software, once the list of unique external IDs is downloaded, an Internet connection is no longer required for continued operation of the system 30. Moreover, if the user credentials supplied do not match any user credentials on record with the third-party provider, the control software, and/or client locking software can refuse to allow proceeding further, potentially exiting, displaying a message indicating that the user is not authenticated or permitted to use the program, or otherwise denying access to the user.

As described above in the disclosure of step 704 for method 70, once the control software and client locking software have been configured and system 30 is ready for use, in step 804 the control software transmits the external ID of the user to the client locking software as part of the control software querying for the presence and status of computer systems and mobile devices running the client locking software. In step 805 the client locking software compares the transmitted external ID with the database of external IDs stored by the client locking software and, if the external ID matches an entry in the database, the client locking software allows the connection and reports its status to the control software in step 806.

The control software ideally supports differing logins corresponding to the various users the initial user sets up with the third-party provider, and transmits the external ID corresponding to the currently logged in user. Additionally, the control software can optionally be configured to allow the addition of new users through the control software or client locking software, with the control software or client locking software respectively contacting the third-party provider to generate a new external ID for the added new user. By using the third-party provider to generate new external IDs, the third-party provider can keep a current list of all of the initial user's authorized users. This facilitates adding additional computer systems or mobile devices to system 30, as the added systems and/or devices need only be provided with the initial user's account information, after which they will download a current list of the external IDs associated with the initial user's account. Alternatively, the control software or client locking software can generate the external ID for an added user, and transmit that information to the third-party provider for updating the user's account. In still other possible implementations, the use of a third-party provider can be completely omitted, with the initial user, following initial providing of credentials and account setup, adding authorized users directly into the control software or client locking software upon initial configuration, and the control software or client login software handling all generation and storage of external IDs and correlating the external IDs with user credentials. Subsequently added computer systems or mobile devices will download the list of external IDs from the existing control software once the client locking software is installed and initially configured. In this way, no Internet connection is initially needed. Still further, the third-party provider can, upon request from the control software or client locking software, supply a list of all external IDs and corresponding user credentials associated with a single account upon receiving an authentication request from any user associated with the single account.

It will further be appreciated and recognized by a person skilled in the relevant art that a user of control software that supplies user credentials unrelated to the user credentials supplied to the client locking software will be unable to access any controlled devices that have been authenticated with the unrelated user credentials, as unrelated user credentials will not have an external ID that is recognized by the client locking software. For example, where third-party provider verification is utilized, control software will receive a first set of external IDs from the third-party provider upon a first user supplying his or her credentials. When a second user, unrelated to the first user, supplies credentials to the client locking software, the third-party provider will provide a second set of external IDs to the client locking software associated with the second user's credentials, which the client locking software will store as a list of authorized external IDs. As the first user and second user are unrelated, the first set of external IDs and second set of external Ms will not have any commonly shared external IDs and, as detailed in the foregoing explanation of method 70, the client locking software will be unable to supply an authorized external ID matching an external ID in the client locking software's database. Thus, the first user will be unable to issue commands to the client locking software, and unable to unlock the associated controlled devices.

Where the implementation of user credentials is tied to a system-wide user authentication (such as user accounts that are well known on most modern operating systems like Windows 10, Mac OS X, and Linux), the disclosed system offers the possibility of integrating user-specific locking, where remotely locked computer system 400 is only locked for certain users. In such an implementation, certain authorized users can be designated as “no lock”, where a lock command would not be executed, thereby allowing designated users to continue to use a computer system in an unrestricted fashion. This functionality is particularly useful when remotely locked computer system 400 is being used by a parent or supervisor, and an automatic schedule for locking has been established. The parent or supervisor could use remotely locked computer system 400 without restriction. Moreover, client locking software can be equipped with functionality to display on command an opportunity to enter new user credentials once a remotely locked computer system 400 is locked, thereby allowing unlocking of a remotely locked computer system 400 by entry of appropriate user credentials.

The control software can be implemented in any fashion now known or later developed in the software technical arts, including a dedicated stand-alone application, an app for a mobile platform such as iOS or Android and downloadable from the relevant marketplace where the control device is a mobile device, or a plug-in module for a more broadly-applicable management or system administration software tool or suite. Likewise, the client locking software (client application) is preferably run as a software, service or daemon (depending on the underlying hardware and operating system platform), which is preferably run with administrative privileges on a system where the service or daemon cannot be shut down by the user with appropriate credentials or permission. The service or daemon preferably remains unobtrusive or otherwise hidden from the user unless specifically called, or if the machine is locked or controlled remotely from the control device. Moreover, the control software and/or the client locking software could be implemented as part of the relevant operating system, which would offer the advantage of system-level operation that could be strongly secured from interference by a user.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A system for remote control of a computing device, comprising:
a control device possessing a network interface, a processor capable of executing software instructions, and a storage unit containing software instructions for execution by the control device processor;
a controlled device possessing a network interface, a processor capable of executing software instructions, and a storage unit containing software instructions for execution by the controlled device processor; and
a network interconnecting the control device and the controlled device via the control device network interface and the controlled device network interface, wherein:
the storage unit of the control device includes software instructions executable by the control device processor for issuing commands over the network to be received by the controlled device, and
the storage unit of the controlled device includes software instructions executable by the controlled device processor for receiving commands over the network from the control device, where the received commands include commands to remove all control of the controlled device from a user physically present at the controlled device.

2. The system of claim 1, wherein removing all control of the controlled device comprises intercepting and disregarding all input to the controlled device.

3. The system of claim 1, wherein the controlled device includes a display, and removing all control of the controlled device includes displaying a window covering substantially all of the display so as to at least partially obscure the previous contents of the display.

4. The system of claim 1, wherein the controlled device is comprised of a plurality of devices, and the software instructions executable by the control device include instructions for selecting one of the plurality of devices to control.

5. The system of claim 1, wherein the software instructions executable by the control device include instructions for polling the network for the presence of one or more controlled devices.

6. The system of claim 1, wherein the software instructions executable by the controlled device include instructions for requesting an external ID from the control device prior to executing any received commands.

7. The system of claim 6, further comprising a third-party provider that generates an external ID for the system user, and for any other persons designated by the user.

8. The system of claim 7, wherein the software instructions executable by the control device and the software instructions executable by the controlled device each include instructions for:
requesting user credentials from the system user upon first execution of the software instructions;
contacting the third-party provider over the network and submitting the user credentials to the third-party provider; and
receiving from the third-party provider the external ID corresponding to the system user.

9. The system of claim 1, wherein the network is a local area network.

10. The system of claim 1, wherein the software instructions executable by the control device and the software instructions executable by the controlled device each include instructions for scheduling a time at a point in the future to remove all control of the controlled device from a user physically present at the controlled device.

11. The system of claim 1, wherein the software instructions executable by the control device and the software instructions executable by the controlled device each include instructions for:
requesting user credentials from the system user upon first execution of the software instructions;
determining an external ID associated with the user credentials;
comparing the external ID with a previously stored user ID; and
only allowing received commands to be executed when the external ID associated with the user credentials matches the previously stored user ID.

12. The system of claim 1, wherein the software instructions executable by the controlled device processor for receiving commands over the network from the control device are run as a daemon that cannot be shut down by a user physically present at the controlled device.

13. The system of claim 12, wherein the software instructions executable by the controlled device processor further comprise instructions for automatically continuing to remove all control of the controlled device following restart of the controlled device.

14. A method for controlling access to a network-connected controlled device comprising:
initiating a control software application on a control device in network communication with a client application running on the controlled device;
sending over the network from the control software application to the client application running on the controlled device commands to disable access to the controlled device to any users physically present at the controlled device; and
receiving and executing the commands by the client application.

15. The method of claim 14 further comprising prior to sending the commands over the network:
requesting credentials from a user of the control device;
determining an ID from the credentials;
comparing the ID with a previously provided external ID; and
allowing the commands to be sent and executed only when the ID and previously provided external ID match.

16. The method of claim 14, further comprising polling of the network by the control software application for the existence of client applications.

17. The method of claim 14, wherein the commands further comprise a command to display a notification message to a user physically present at the controlled device.

18. The method of claim 14, wherein the controlled device comprises either a computer or a mobile device.

19. The method of claim 14, wherein the control device comprises either a computer or a mobile device.

20. A system for controlling access to one or more network-connected controlled devices, comprising:
a control device connected to the network so as to be in data communication with the one or more controlled devices;
a control software program that is executed on the control device and polls the network to locate the one or more controlled devices;
a client locking software program that is executed on each of the one or more controlled devices and capable of receiving and executing commands received from the control software program for controlling access to a user that is physically present at the controlled device; and
a third-party provider that stores a set of external IDs associated with a set of user credentials connected to the network so as to be in data communication with the control device and the one or more controlled devices, wherein:
a user of the system provides user credentials to the control software program and client locking software program on each of the one or more controlled devices,
the control software program and client locking software program on each of the one or more controlled devices submits the user credentials to the third-party provider,
the third-party provider provides the external ID associated with the submitted user credentials to the control software program and client locking software program,
the client locking software program stores the provided external ID,
the control software program submits the external ID to the client locking software program prior to sending commands to the client locking software program, and
the client locking software program receives and executes commands from the control software program only when the submitted external ID matches the external ID stored by the client locking software.
